(19) United States
(12) Patent Application Publication
(10) Pub. No.: US 2009/0120773 A1
(43) Pub. Date: May 14, 2009

(54) METHOD FOR QUENCHING A FAULT ARC, WITHIN A MEDIUM-VOLTAGE AND HIGH-VOLTAGE SWITCHGEAR ASSEMBLY, AS WELL AS SHORTING DEVICE ITSELF

(75) Inventors: Dietmar GENTSCH, Ratingen (DE); Harald Fink, Ratingen (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/277,490

(22) Filed: Nov. 25, 2008

Related U.S. Application Data
(63) Continuation of application No. PCT/EP2007/004671, filed on May 25, 2007.

(30) Foreign Application Priority Data
May 30, 2006 (DE) 10 2006 024 991.7

(51) Int. Cl. H01H 1/06

(52) U.S. Cl. 200/239; 361/2

(57) ABSTRACT

The disclosure relates to a method for quenching a fault arc in a medium-voltage and high-voltage switchgear assembly, in which at least one shorting element is connected between the phases of a three-phase distribution board. In order to allow more reliable fault arc quenching in this case, the disclosure proposes that the fault arc is detected by means of sensors and an explosive charge which acts directly on the shorting switching element fires the shorting switching element at a conical contact structure which is connected to the three-phase conductors and is configured in a complementary manner to the shorting switching element, in such a manner that the complementary contours of the shorting switching element and of the three-phase conductors result in self-locking retention in the shorting position, without any holding force.

### RELATED APPLICATIONS

This application claims priority under 35 U.S.C. §119 to EP Application 10 2006 024 991.7 filed in Germany on May 30, 2006, and as a continuation application under 35 U.S.C. §120 to PCT/EP2007/004671 filed as an International Application on May 25, 2007 designating the U.S., the entire contents of which are hereby incorporated by reference in their entireties.

### TECHNICAL FIELD

A medium-voltage and high-voltage switchgear assembly is disclosed, in which at least one shorting element is connected between the phases of a three-phase distribution board.

### BACKGROUND INFORMATION

An object of medium-voltage switchgear assemblies is to distribute the energy flow and to ensure safe operation control. A fault arc which occurs within a switchgear assembly produces a major pressure rise of the gas, as a result of its temperature, in a time period of a few milliseconds, which can lead to destruction of the switchgear assembly by explosion. Measures are therefore taken in order to dissipate the pressure as quickly as possible.

The occurrence of arcs can be restricted to a very major extent by suitable design, for example by means of internal subdivision of the switch panel (compartmentalization). For this purpose, the individual switch panels of a switchgear assembly have pressure-relief openings or pressure-relief channels, via which the gas can flow away into the surrounding area. The effects of a fault arc can in consequence be limited primarily by a reduction of the arc duration.

Exclusively three-phase short-circuiting devices such as these are known, which switch in air or sulphur hexafluoride. In any case, the switching and isolation capacity are reduced as a result of the high inrush current in the event of repeated switching. In contrast, when a vacuum interrupter chamber is used, these electrical characteristics remain virtually unchanged as the number of switching operations increases.

The switchgear assemblies manufactured by ABB AG use encapsulation for personnel protection, and this offers adequate protection when an internal fault occurs (for example when an arc is formed in a gas area (fault arc)). The energy flow which occurs as a result of a fault arc is controlled and distributed within the switchgear assembly. This encapsulation is designed to be appropriately pressure-resistant, for this purpose. Adequate measures are taken against the encapsulation melting on or melting through, ensuring that the device is resistant to arcs and thus that a switchgear assembly can be operated safely.

In individual applications, shorting systems are already in use which relate in general to single-phase systems (for example being used to ground or between the phases), or else which are of a three-phase configuration.

DE 19746809A1 discloses a shorting device for a fault arc protective apparatus for use in switchgear assemblies for the distribution of electrical power having a gas generator, and a shorting element which is driven directly by the gas generator, with the shorting element comprising a shorting piston with at least one cylindrical section and one conical section, with the aim of allowing a switching process without any bouncing within one millisecond while being able to transmit high currents, for example of 100 kA, for several hundred milliseconds, e.g., 500 milliseconds. This is achieved by the shorting piston comprising a front cylindrical section which is moved suddenly into a likewise cylindrical hole in a shorting part, and by the front cylindrical section being provided with a clearance fit in the hole.

### SUMMARY

A shorting switching device of this generic type is disclosed, such that arcing in the shorting switching device can be reliably prevented and such that the fault arc that is to be quenched in this way can be safely commutated in the medium-voltage or high-voltage switchgear assembly.

A method for quenching a fault arc in a medium-voltage and high-voltage switchgear assembly is disclosed, in which at least one shorting switching element is connected between the phases of a three-phase distribution board, wherein the fault arc is detected by means of sensors and an explosive charge which acts directly on the shorting switching element fires the shorting switching element at a conical contact structure which is connected to the three-phase conductors and is configured in a complementary manner to the shorting switching element, in such a manner that the complementary contours of the shorting switching element and of the three-phase conductors result in self-locking retention in the shorting position, without any holding force.

A shorting switching device for a medium-voltage or high-voltage device is disclosed, in which the shorting switching element is provided with an operating explosive charge, via which the shorting switching element can be accelerated onto the three-phase conductor structure, wherein the shorting switching element is provided with an external cone, and the contact structure which is electrically connected to the three-phase conductor is provided with a correspondingly complementary conical opening.

In another aspect, a method for quenching a fault arc in a power switchgear assembly is disclosed, in which at least one shorting switching element is connected between the phases of a three-phase distribution board. Such a method comprises detecting a fault arc using sensors; directing an explosive charge onto a shorting switching element to fire the shorting switching element at a conical contact structure which is connected to the three-phase conductors and is configured in a complementary manner to the shorting switching element; and shorting of position in such a manner that complementary contours of the shorting switching element and of the three-phase conductors result in self-locking retention in the absence of a holding force.

### BRIEF DESCRIPTION OF THE DRAWINGS

Other objects and advantages will become apparent from the following detailed descriptions when read in conjunction with the drawings, wherein:

FIG. 1 shows an exemplary “three-phase” shorting device-vacuum interrupter chamber;

FIG. 2 illustrates an exemplary single-phase shorting device-vacuum interrupter chamber;

FIG. 3 shows an exemplary circuit diagram with three phases; and

FIG. 4 shows another exemplary circuit diagram with three phases.

The disclosure as illustrated in the drawings is described in more detail in the following text.

### DETAILED DESCRIPTION

With regard to the method, the essence of the disclosure is that the fault arc is detected by means of sensors and an explosive charge which acts directly on the shorting switching element fires the shorting switching element at a conical contact structure which is connected to the three-phase conductors and is configured in a complementary manner to the shorting switching element, in such a manner that the complementary contours of the shorting switching element and of the three-phase conductors result in self-locking retention in the shorting position, without any holding force.

Known shorting devices used in conjunction with the upstream circuit breaker switch too slowly. In general, furthermore, they are technically excessively complicated and costly, because of their three-phase configuration. During a switching process, these shorting devices in all three phases connect the previously live current path to ground or else between the individual phases. This in turn requires a compact, costly ground current path in order to carry the generally high fault current for a short time. Furthermore, the current means that both the switching capacity and the isolation capacity are reduced throughout the life.

Furthermore, the cylindrical configuration of the shorting switching element and the mating contact, with these being matched to one another except for a certain amount of clearance, is technically too difficult. Normal bearing clearances or discrepancies on triggering result in a non-directed shot, and the cylinder contour, whose dimensions are too precise, is seated on the mating contact with the discrepancy of only a tenth of a millimeter at the edge, so that the contact can no longer close correctly, resulting in a considerable arc.

In this case, the disclosure solves two major technical problems. On the one hand, the use of sensors, that is to say in the end electronics, for fault arc detection ensures a short reaction time. On the other hand, the correspondingly complementary-contoured contact points mean that, after triggering of the explosive charge and acceleration of the shorting switching element, not only is the shorting contact reached as quickly as possible, but is also held. Complementary structuring prevents the shorting switching element from being able to bounce away from it after initial contact, once again producing an arc in the process. In fact, the complementary structure ensures an arc-free shorting contact.

In this case, it is advantageous for the shorting switching element to be operated within a time of T≦10 milliseconds.

With regard to a shorting switching device of this generic type, the essence of the disclosure is that the shorting switching element is provided with an external cone, and the contact structure which is electrically connected to the three-phase conductor is provided with a correspondingly complementary conical opening.

This specific complementary structure of the external cone and of the internal cone means that the external cone of the shorting switching element is fired by means of an explosive charge into the conical opening in the mating contact, where it is held firmly with contact being made, without any additional holding forces being required. This characteristic will be referred to here in the following text as self-locking. The fact that the contact point can thus no longer be detached also prevents any arcing.

Another exemplary embodiment can have the flank angle of the cone and/or of the conical opening specified between 2° and 60°. The stated self-locking is ensured in this definitive area of the conical shaping, reliably preventing the conical shorting contact from bouncing back out of the conical opening.

Such an exemplary embodiment can have a shorting switching element and a contact structure arranged within a vacuum chamber, and result in a single-phase shorting switching device. This results in a form which is not only compact but also safe.

Another aspect is that one shorting switching element and one contact structure are in each case connected between in each case two phases of the three-phase conductor system.

Another exemplary embodiment can have in each case one shorting switching element and one contact structure provided per phase of the three-phase conductor system, and the three contact structures are electrically interconnected at a star point.

In this case, the star point can be grounded.

In yet another exemplary embodiment, the shorting switching device is provided with at least one sensor which is arranged in the area of the switching elements of the medium-voltage or high-voltage switchgear assembly and is used to detect a fault arc, by means of which a triggering device for the shorting switching device can be operated within a time T≦10 ms.

The shorting device is arranged within a switchgear assembly comprising one or more switch panels, directly in the feed current path.

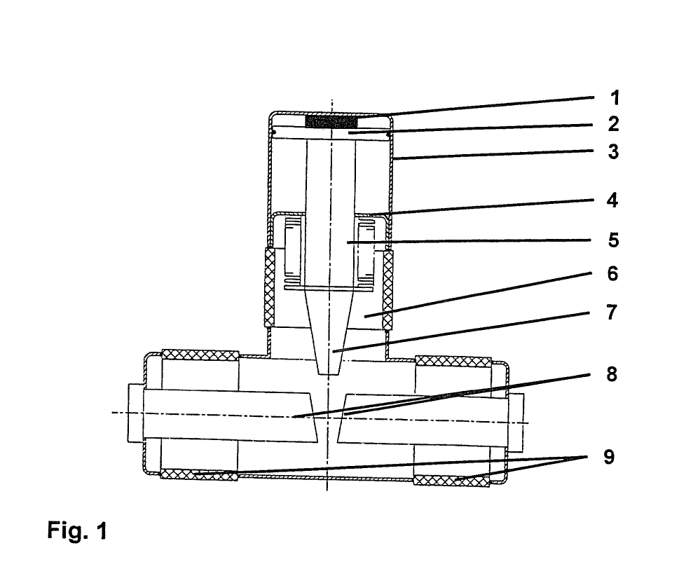

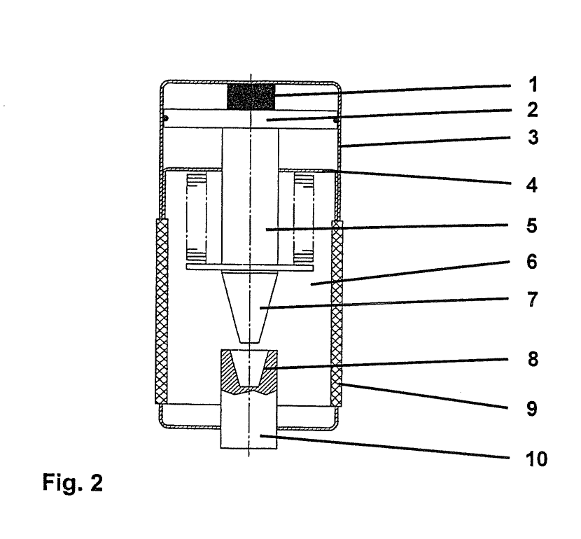

During a switching process, it “shorts” (in the event of a fault) the phases by closing the circuit in parallel with the feed switch, with any arc that may have occurred in an outgoer panel being quenched without delay. It should be stressed that the shorting device may comprise only “a three-phase” (FIG. 1) or else “a plurality of individual” vacuum interrupter chambers (FIG. 2). If the individual “plurality” (for example three of them) of vacuum interrupter chambers are connected in star, then the star point can be grounded. If grounded, it is necessary to use a more complex grounding current path within a switchgear assembly. The use of vacuum technology ensures current-independent, constant functionality throughout the entire life.

The drastic reduction in the arcing time, that is to say the considerable reduction in the mechanical and thermal load within a switchgear assembly in the event of a fault, allows low-cost, compact switch panels and components to be developed and manufactured. The disclosure is used in air-insulated or gas-insulated medium-voltage switchgear assemblies for primary and secondary distribution.

A device for quenching of a fault arc in a closed or open switchgear assembly is described which, in particular on the basis of a phase short between the phases (R, Y; Y, B) with “two” vacuum interrupter chambers or with “one” vacuum interrupter chamber, shorts the three phases (R, Y and B) to one another in the event of a fault. When a fault occurs, in the present case a fault arc, the two vacuum interrupter chambers or the “three-phase” vacuum interrupter chamber close or closes, into which the current from the fault arc is thus commutated. This is achieved by the use of an explosive sleeve (explosive charge), which is arranged on one side of a vacuum interrupter chamber and which, after tripping, accelerates the moving conductor in the direction of the fixed contact. For a firm connection of the two conductors after connection of the unit (shorting), the two conductor contact pieces (switching contact piece and fixed contact piece) are on the one hand conical and on the other hand tulip-shaped, so that the so-called “self-locking” occurs after connection, and the two components remain in the closed state. There is no need to apply any permanent contact pressure in the connected state.

If the shorting device comprises only “one” vacuum interrupter chamber, this vacuum interrupter chamber contains the three conductors of the phases (R, Y and B), and the configuration corresponds to a star shape. However, the star point cannot be grounded in this arrangement. The device is configured such that two conductors are installed fixed in a vacuum interrupter chamber and one conductor is “perpendicular” (at right angles) to the two conductors, and is configured such that it can move. The moving conductor is accelerated by an explosive sleeve (after its explosion) in the direction of the two other conductors, and produces the three-phase short in the device. This vacuum interrupter chamber also contains contact pieces which remain in the connected (shorted) position for self-locking after shorting.

FIG. 1 shows an exemplary “three-phase” shorting device-vacuum interrupter chamber (VK) with the conductors R; Y; B 8 and 5, which has a moving supply line 5 in addition to the two supply lines 8 which are firmly soldered into the vacuum interrupter chamber. A piston 2 is located on the moving supply line 5, outside the vacuum 6 and above the cover 4, and can be configured as shown. An explosive charge 1 is located above the piston and holds the piston 2 in the upper position, so that the contact pieces 7 and 8 are held apart. A further option for holding the piston 2 in this position can be achieved by a wire or else a rod between the piston and the cover 3. Once a fault has been detected, the explosive charge 1 (light sensor+electronics evaluation unit+initiation−>trigger output) is caused to explode, after initiation. In the pressure area, in this case in the form of a pressure-resistant cover 3, the piston is accelerated together with the moving supply line 5 into the vacuum interrupter chamber. The two conductors are isolated by means of an isolator 9. During the process, the contact points 7 and 8 are closed very quickly. The supply line contact piece 7 is configured to be correspondingly conical, so that, after connection (the closing of the contact pieces), the contact pieces are reliably retained in the connected position, by virtue of the mechanical self-locking. As illustrated here, a bellows can be used to provide vacuum sealing. The current can be transmitted on the moving side by means of a multi-contact sliding system, or else by the use of a flexible strip.

FIG. 2 illustrates an exemplary single-phase shorting device-vacuum interrupter chamber (VK) 9, which can be connected between the three conductors R, Y; and Y; B. Furthermore, it is possible for one vacuum interrupter chamber 9 to be arranged for each phase. In this case, the resultant star point can be configured in the switch form, to be open or else grounded. In addition to a permanently soldered-in supply line 1 with a contact area 8, the vacuum interrupter chamber 9 has a moving supply line 5. An isolator 9 provides isolation between the two conductors. A piston 2 is located on the moving supply line 5 with a conical contact area 7, outside the vacuum and above the cover 4, and can be configured as shown. An explosive charge 1 is located above the piston 2 and holds the piston in the upper position, so that the contact pieces are held apart in the vacuum 6. A further possible way to hold the piston in this position is to provide a wire or else a rod between the piston and the cover 3. Once a fault has been detected, the explosive charge 1 (light sensor+electronics evaluation unit+initiation−>trigger output) is caused to explode, after initiation. In the pressure area, in this case in the form of a pressure-resistant cover, the piston is accelerated together with the moving supply line into the vacuum interrupter chamber. In this case, the contact point is closed very quickly. The supply line contact piece is configured to be correspondingly conical, so that, after connection (the closing of the contact pieces), the contact pieces are reliably retained in the connected position, by virtue of the mechanical self-locking. As illustrated here, a bellows can be used to provide vacuum sealing. The current can be transmitted on the moving side by means of a multi-contact sliding system, or else by the use of a flexible strip.

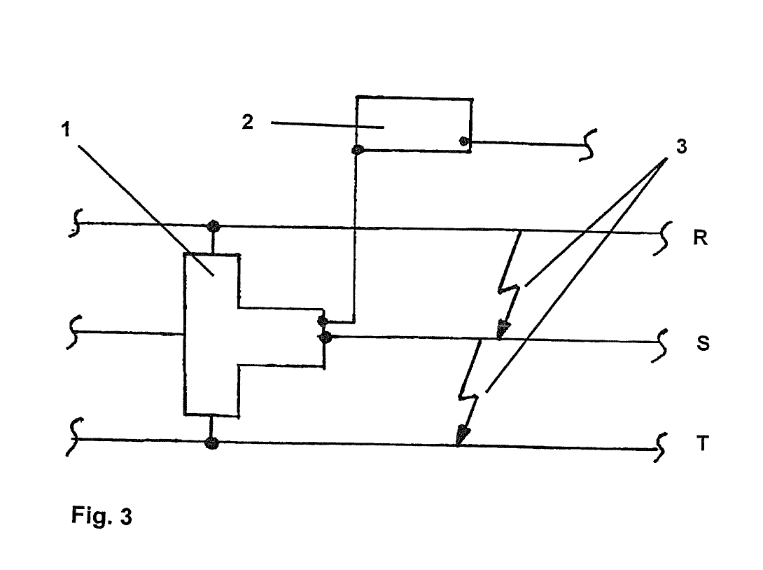

FIG. 3 shows an exemplary circuit diagram with the three phases R; Y; B. The three-phase shorting device 1 is located for protection purposes in the area of the three phases, is configured as shown in FIG. 1 and is connected to the three phases. If a fault arc 3 occurs between the phases or to ground, the arc is detected, for example optically, and the explosive sleeve in the vacuum interrupter chamber 1 is caused to explode via the control unit 2. Once the contact pieces have closed, the current is commutated into the vacuum interrupter chamber 1, and the fault arc 3 is quenched.

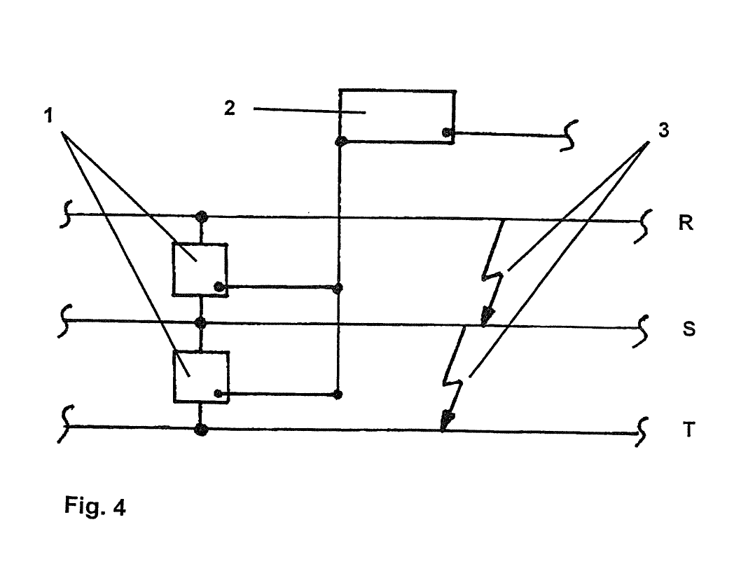

FIG. 4 shows an exemplary circuit diagram with the three phases R; Y; B. “Single-phase” shorting devices 1 are located for protection purposes between the three phases, are configured as shown in FIG. 2, and are connected to the phases (R, Y; Y, B). If a fault arc 3 occurs between the phases or to ground, the arc is detected, for example optically, and the explosive sleeve in the vacuum interrupter chamber 1 is caused to explode via the control unit 2. Once the contact pieces have closed, the current is commutated into the vacuum interrupter chamber 1, and the fault arc 3 is quenched.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for quenching a fault arc in a medium-voltage and high-voltage switchgear assembly, in which at least one shorting switching element is connected between the phases of a three-phase distribution board, wherein
a fault arc is detected by means of sensors and an explosive charge which acts directly on the shorting switching element fires the shorting switching element at a conical contact structure which is connected to the three-phase conductors and is configured in a complementary manner to the shorting switching element, in such a manner that the complementary contours of the shorting switching element and of the three-phase conductors result in self-locking retention in the shorting position, without any holding force.

2. The method as claimed in claim 1, wherein
the shorting switching element is generated within a time of T≦10 ms from the occurrence of the fault arc.

3. A shorting switching device for a medium-voltage or high-voltage device, in which a shorting switching element is provided with an operating explosive charge, via which the shorting switching element can be accelerated onto a three-phase conductor structure, wherein
the shorting switching element is provided with an external cone, and the contact structure which is electrically connected to the three-phase conductor is provided with a correspondingly complementary conical opening.

4. The shorting switching device as claimed in claim 3, wherein
the flank angle of the cone and/or of the conical opening is between 2° and 60°.

5. The shorting switching device as claimed in claim 3, wherein
a shorting switching element and a contact structure are arranged within a vacuum chamber, and result in a single-phase shorting switching device.

6. The shorting switching device as claimed in claim 3, wherein
one shorting switching element and one contact structure are in each case connected between in each case two phases of the three-phase conductor system.

7. The shorting switching device as claimed in claim 3, wherein
in each case one shorting switching element and one contact structure are provided per phase of the three-phase conductor system, and in that the three contact structures are electrically interconnected at a star point.

8. The shorting switching device as claimed in claim 7, wherein
the star point is grounded.

9. The shorting switching device as claimed in claim 3, wherein
the shorting device has at least one sensor which is arranged in the area of the switching elements of the medium-voltage or high-voltage switchgear assembly and is used to detect a fault arc, by means of which a triggering device for the shorting switching device can be operated within a time T≦10 ms.

10. The shorting switching device as claimed in claim 4, wherein
a shorting switching element and a contact structure are arranged within a vacuum chamber, and result in a single-phase shorting switching device.

11. The shorting switching device as claimed in claim 5, wherein
one shorting switching element and one contact structure are in each case connected between in each case two phases of the three-phase conductor system.

12. The shorting switching device as claimed in claim 5, wherein
in each case one shorting switching element and one contact structure are provided per phase of the three-phase conductor system, and in that the three contact structures are electrically interconnected at a star point.

13. The shorting switching device as claimed in claim 8, wherein
the shorting device has at least one sensor which is arranged in the area of the switching elements of the medium-voltage or high-voltage switchgear assembly and is used to detect a fault arc, by means of which a triggering device for the shorting switching device can be operated within a time T≦10 ms.

14. A method for quenching a fault arc in a power switchgear assembly, in which at least one shorting switching element is connected between the phases of a three-phase distribution board, comprising:
detecting a fault arc using sensors;
directing an explosive charge onto a shorting switching element to fire the shorting switching element at a conical contact structure which is connected to the three-phase conductors and is configured in a complementary manner to the shorting switching element; and
shorting of position in such a manner that complementary contours of the shorting switching element and of the three-phase conductors result in self-locking retention in the absence of a holding force.
